(19) United States
(12) Patent Application Publication
(10) Pub. No.: US 2009/0044766 A1
(43) Pub. Date: Feb. 19, 2009

(54) Method for disassembling a boiler

(75) Inventor: Yoshihide Yoshino, Koto-ku (JP)

Correspondence Address: BIRCH STEWART KOLASCH & BIRCH, PO BOX 747, FALLS CHURCH, VA, 22040-0747, US

(73) Assignee: BESTERRA Co., Ltd.,, Tokyo (JP)

(21) Appl. No.: 11/889,850

(22) Filed: Aug. 16, 2007

(51) Int. Cl. F22B 1/00; B66C 1/00

(52) U.S. Cl. 122/4 R; 294/1.1

(57) ABSTRACT

A method for disassembling a boiler supported on a supporting structure is disclosed. The method includes a holder installation step for providing a vertically extendable ascent-descent holder below the boiler; a holder lifting step for increasing a height of the ascent-descent holder to a position close to or in contact with a lower end of the boiler; a cutting step for cutting off a lower part of the boiler, the lower part extending from the lower end of the boiler to a predetermined height; and a removal step for removing the lower part from the holder, after the lower part being cut off and the weight of the lower part being transferred to the ascent-descent holder; the holder installation step, the holder lifting step, the cutting step, and the removal step are repeatedly carried out for successively disassembling the boiler from a bottom side thereof.

### BACKGROUND OF THE INVENTION

1. Field of the Invention

The present invention relates to a method for disassembling a boiler, and more specifically, to a method for disassembling a boiler which is supported on a supporting structure by being suspended therefrom.

2. Discussion of the Related Art

A boiler is used, for instance, in a thermoelectric power plant, for generating steam at a high temperature and at a high pressure. The steam is generated from a tightly closed apparatus and is used for obtaining energy for rotating a power-generating turbine. FIG. 4 is a diagram for explaining a large boiler 10 for use in a thermoelectric power plant. The boiler 10, which usually has a weight of more than 1000 tons, is installed by means of so-called “top support method”. In top support method, a top part of the boiler 10 is supported by a large supporting structure 12 substantially constructed by a steel frame including columns 12a, beams 12b and a main girder 12c. The boiler 10 is retained on the supporting structure 12 by being suspended from the main girder 12c. One end of a plurality of suspension rods 14 is connected to the main girder 12c and another end of the suspension rods 14 is connected to a top part 10a of the boiler 10. Here, the number of rods is, for instance, 20 to 100 per a supporting structure 12.

Generally speaking, the boiler 10 comprises a furnace unit 20 and a heat recovery area (rear heat-exchanging unit) 22. The furnace unit 20 has a hollow structure, for instance, a multi-sided hollow structure. In the furnace unit 20, fuel is burnt by ignition burners (not shown) provided on the lateral wall of the furnace unit 20. Therefore, combustion gas is generated. The heat recovery area 22 is provided on a lateral side of the furnace unit 20, and an upper part of the heat recovery area 22 communicates with an upper part of the furnace unit 20. The heat recovery area 22 also has a hollow configuration and the vertical length of the heat recovery area 22 is shorter than that of the furnace unit 20. Namely, the lower end of the heat recovery area 22 is positioned higher than that of the furnace unit In the boiler 10. Furthermore, a plurality of superheaters 24 (24-1 to 24-5), shown by a dash-dotted line, are contained in the hollow interior of the heat recovery area 22. By using the superheaters 24, water is converted into steam.

The combustion gas generated in the furnace unit 20 flows through a route shown by arrows 200 and 202. The heat of the combustion gas is subjected to a heat exchange in the superheaters 24, so as to rotate a power-generating turbine, to produce electrical energy. The combustion gas after the heat exchange process, that is, gas having a decreased temperature passes through a gas duct 26, shown by the long dashed double-short dashed lines and then to an electrical precipitator (not shown). As the superheater 24, it is possible to use a superheater or economizer, including therein a pipe for carrying water or steam therethrough.

FIG. 5 is a diagram for explaining a structure of a furnace wall 16 for the furnace unit 20. The furnace wall 16, which is a part of a boiler wall, includes an outer casing 16a and a fire resistant material 27b provided on an inner surface of the outer casing 16a (corresponding to the inner periphery of the furnace unit 20). The outer casing 16a is made of a metal, and the fire resistant material layer 16b is made of a fire-resistant material. Further, the fire-resistant material can be replaced by an insulating material for thermal control, which is cheaper than the fire-resistant material. On an inner side of fire resistant layer 16b, heat exchange pipes 16c are provided for transporting a liquid or steam therein. By the provision of the heat exchange pipes 16 c, a heat exchange operation is carried out also on the furnace wall 16. Moreover, it is possible that an inner casing made of a metal is further provided on the fire resistant layer 16b on the opposite side with respect to the outer casing 16a. The heat recovery area 22 frequently has an inner wall made of a fire resistant material.

Considering the energy conversion efficiency of the above-described combustion heat to other kinds of energy, such as superheated steam, it is sometimes necessary to replace a boiler with a new boiler having an improved structure for increasing energy conversion efficiency. For the replacement, the boiler 10 has to be disassembled.

There is a method for disassembling the boiler 10 by preparing a scaffold around the boiler 10, while the boiler 10 is maintained in the aforementioned suspended state by the suspension rods 14. Based on this method, structural members of the boiler 10 are gradually cut from the bottom of the boiler 10 by an operator on the scaffold. Then, the cut pieces of the structural members fall directly from the height where the boiler is cut by the operator to the ground.

In addition to the above, there is another method for disassembling a large boiler, i.e., the so-called jack-down method, as disclosed in Japanese Kokai Patent Publication 1999 (Heisei 11)-270157. According to this publication, a jack is provided on the top of a boiler building (shed) as described in FIG. 2. The boiler is disassembled from the bottom thereof, with the boiler being lowered by the jack.

Based on the above-described first method, wherein the suspended boiler is disassembled by using a scaffold, however, it could be extremely dangerous at a point where the cut pieces of boiler structural members fall. Moreover, when a fire resistant inner wall material in the furnace wall 16 is cut, the cut fire resistant material is scattered to the surroundings. When the fire resistant material includes a harmful substance such as asbestos, it is harmful the environment and people to have the fire resistant substance scattered in this way.

On the other hand, according to Japanese Kokai Patent Publication 1999 (Heisei 11)-270157, it is necessary to gradually lower the large boiler which can weigh 1000 tons or more by using the jacks, with the entire weight of the boiler being maintained on the jacks. Therefore, the lowering operation is laborious and complicated, and requires a great deal of work. Moreover, it is necessary to pay extreme attention to safety during such an operation. For example, it is necessary to control the balance of the boiler suspended from the plurality of jacks. Further, it is necessary to consider all the arrangement of pipes, apparatuses, cables, and wirings or the like which connect the boiler and the boiler building to each other, and to apply necessary pretreatment to the arrangement, before lowering the boiler. Such pretreatment is time consuming. It would also be possible to prepare jacks to lower precisely while maintaining the horizontal balance. However, the preparation of such jacks is extremely expensive.

### SUMMARY OF THE INVENTION

It is therefore an object of the present invention to provide a method for disassembling a boiler supported on a supporting structure by suspending therefrom which can be carried out easily and economically, without any problems with respect to safety and environment concerns.

The method comprises a holder installation step for providing a vertically extendable ascent-descent holder (ascent-descent stage) below the boiler; a holder lifting step for increasing a height of the ascent-descent holder to a position close to or in contact with a lower end of the boiler; a cutting step for cutting off a lower part of the boiler, the lower part extending from the lower end of the boiler to a predetermined height; and a removal step for removing the lower part from the holder, after the lower part has been cut off and the weight of the lower part has been transferred to the ascent-descent holder; the holder installation step, the holder lifting step, the cutting step, and the removal step being repeatedly carried out for successively disassembling the boiler from a bottom side thereof.

The above object of the invention is achieved also by a method for disassembling a boiler supported on a supporting structure by suspending therefrom; comprising: a holder installation step for providing a vertically extendable ascent-descent holder below the boiler, the ascent-descent holder being extended by the provision of one or more jacks provided below the boiler; a holder lifting step for increasing a height of the ascent-descent holder to a position close to or in contact with a lower end of the boiler; a cutting step for cutting off a lower part of the boiler, the lower part extending from the lower end of the boiler to a predetermined height; and a removal step for removing the lower part from the holder, after the lower part has been cut off and the weight of the lower part has been transferred to the ascent-descent holder; the holder installation step, the holder lifting step, the cutting step, and the removal step being repeatedly carried out for successively disassembling the boiler from a bottom side thereof.

According to the method of the present invention, the boiler is disassembled from the bottom thereof. In the present invention, an ascent-descent holder is always maintained in a position which is close to the lower end of the boiler, or in contact therewith. Therefore, cut parts of the boiler do not fall to the ground, and the weight of the cut parts is shifted onto the holder with substantially no impact on the holder. Thereafter, the cut part is removed from the holder, without falling to the ground. Since the method of the invention is performed by repeating the above-described safe steps, the disassembling operation with respect to the boiler is carried out in a safe way. Moreover, the environmental safety is preserved since the cut part does not crash or strongly impact on the ground or the surrounding area.

According to the present invention, it is also possible to decrease laborious and complicated work, for instance, lowering the entire body of the boiler. Therefore, the disassembling operation can be carried out easily and speedily. Furthermore, the ascent-descent holder can be relatively economically provided, because the holder needs only to support the weight of the cut part of the boiler.

It is another object of the present invention to provide a method for cheaply disassembling the boiler by separately disassembling a furnace unit and a heat recovery area of the boiler by using a single holder without increasing the size of the holder.

The object is achieved by the method for disassembling a boiler, wherein the boiler comprises a furnace unit, and a heat recovery area provided adjacent to the furnace unit, an upper part of the furnace unit communicating with an upper part of the heat recovery area, the ascent-descent holder being provided below the furnace unit in the holder installation step, and the furnace unit being subjected to the holder lifting step, cutting step and the removal step for disassembling the furnace unit from a bottom side thereof, the ascent-descent holder being displaced to a position below the heat recovery area in the holder installation step after the furnace unit is substantially disassembled, the heat recovery area being subjected to the holder lifting step, the cutting step and the removal step for disassembling the heat recovery area from a bottom side thereof.

A further object of the invention is to provide a method for disassembling the boiler so that metal or small particles and dust of fire-resistant material, which are generated during the cutting step of the boiler, are not released to the outside environment and are retained in the interior of the boiler. This object is attained by the method for disassembling a boiler, wherein the interior of the boiler in the course of the cutting step is set to a negative pressure.

The above-discussed retention is made possible by creating an air flows into the boiler from the opening formed by cutting the boiler. As a result, environmental problems will not occur when carrying out the cutting operation.

Still another object of the present invention is to provide a method for disassembling the boiler so that a cut part of the boiler can be stably supported on the holder without tilting or falling from the holder. Thus, the cutting operation can be smoothly and stably performed.

This object is achieved by the method for disassembling a boiler, wherein the cutting step is carried out by cutting the boiler along horizontally extending cutting planes.

Yet another object of the present invention is to provide a method for disassembling the boiler, in which the boiler can be stably cut in the cutting step without the cut part tilting or shifting on the holder. This object is achieved by the method for disassembling a boiler, wherein the ascent-descent holder is pressed against the lower end of the boiler with a predetermined pressure in the holder lifting step.

### BRIEF DESCRIPTION OF THE DRAWINGS

A more complete appreciation of the invention and many of the attendant advantages thereof will be readily perceived as the same becomes better understood by reference to the following detailed description when considered in connection with the accompanying drawings, wherein:

FIG. 1A is a diagram for explaining a step for providing an ascent-descent holder, and a step for increasing the height of the ascent-descent holder;

FIG. 1B is a diagram for explaining a step for cutting off the boiler;

FIG. 1C is a diagram for explaining a step for removing the cut part from the rest of the boiler;

FIG. 2A is a diagram for explaining a step for cutting off the furnace unit;

FIG. 2B is a diagram for explaining a step for removing the cut part from the rest of the furnace unit;

FIG. 3A is a diagram for explaining a step for cutting off the boiler;

FIG. 3B is a diagram for explaining a step for lowering the height of the ascent-decent holder with carrying the cut part of the boiler thereon;

FIG. 4 is a diagram for explaining a boiler for use in a thermoelectric power plant; and

FIG. 5 is a diagram for explaining a furnace wall in the furnace unit.

### DETAILED DESCRIPTION OF THE INVENTION

Other features of this invention will become apparent in the course of the following description of exemplary embodiments, which are given for illustration of the invention and are not intended to be limiting thereof.

Exemplary embodiments of the present invention will now be explained by referring to figures.

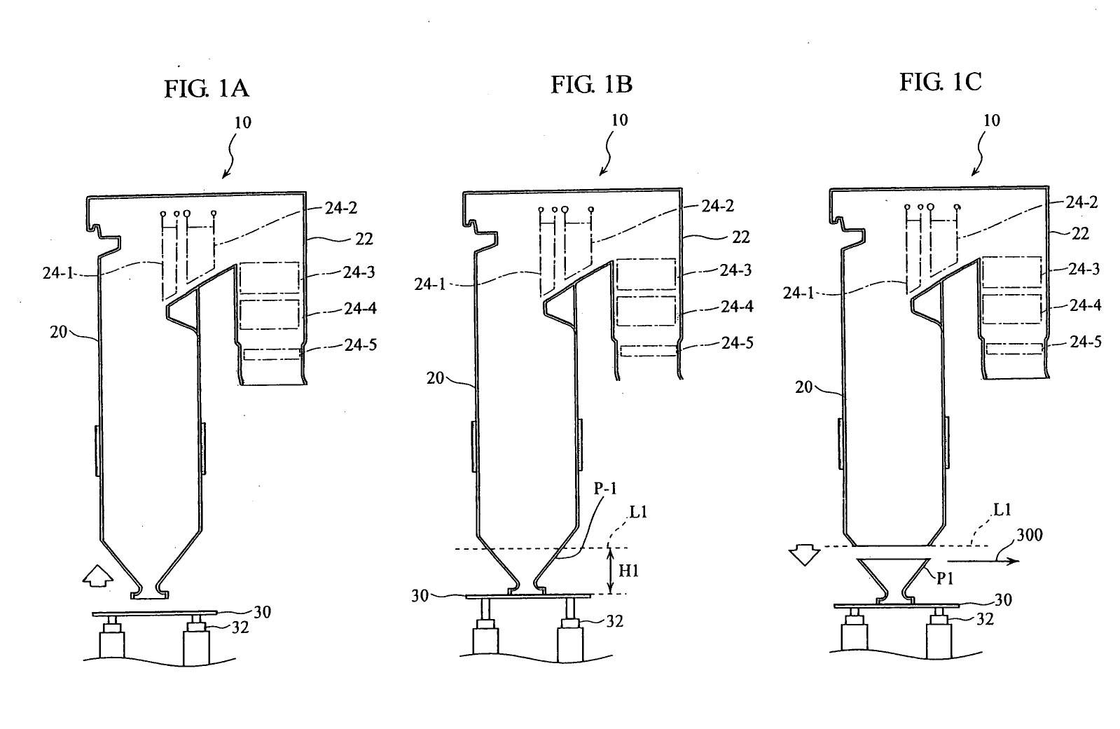

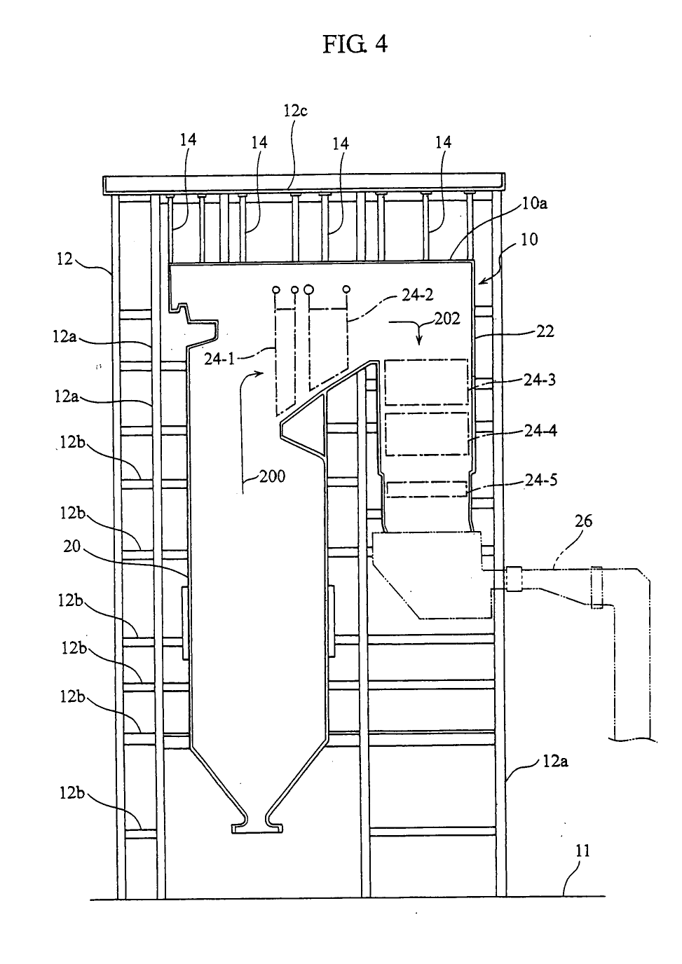

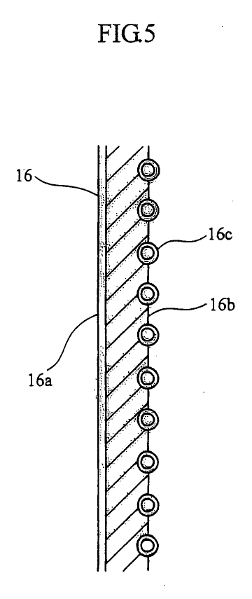

FIGS. 1A to 1C are diagrams for explaining a procedure for disassembling a boiler according to the present invention. In the present embodiment, a boiler 10 which is shown in FIG. 4 is subjected to the disassembling operation.

FIG. 1A is a diagram for describing a first step, that is, a step for providing an ascent-descent holder 30 (holder installation step). The ascent-descent holder 30 is supported by a jack/jacks 32 provided on the bottom surface of the holder 30. The jack 32 can be extended or shortened in a vertical direction so that the vertical position of the holder 30 thereon can be variously changed. Namely, it is possible for the jacks 32 to support the boiler 10 at any height, for instance, a position close to the ground, or at a position corresponding to the top of the boiler 10. In the present embodiment, the jacks 32 are provided directly on the ground below the boiler 10. However, it is also possible to provide the jacks 32, for instance, on a concrete base which determines a standard installation position below the boiler 10, or on a floor.

The holder 30 has a planer configuration for supporting at least either one of a furnace unit 20 and a heat recovery area 33 from the bottom side of the boiler 10. In the present invention, the ascent-descent holder 30 is provided at a position below the boiler 10. It is preferable to provide the holder 30 immediately below the furnace 20 as shown in FIG. 1A.

FIG. 1B is a diagram for explaining a step for cutting off the boiler. FIG. 1B shows that the height of the ascent-descent holder 30 has been increased based on an operation of increasing the length of the jacks 32 (expansion operation). Therefore, the holder 30 can be brought to be close to or in contact with the lower end of the furnace 20 (holder lifting step). In FIG. 1B, the holder 30 is in contact with the lower end of the furnace 20. With maintaining the furnace 20 on the holder 30, a lower part of the furnace 20 is cut off from the boiler 10 (cutting step). The cutting step can be carried out by an operator by using a gas burner. For instance, it is possible to horizontally cut the furnace 20 along a dotted line L-1, so that a cut part P-1 with an appropriate height H1 to the bottom of the furnace 20 can be obtained, as shown in FIG. 1B. According to the cutting step, the weight of the cut part P-1 is transferred to the holder 30. In other words, the cut part P-1 is entirely loaded on the holder 30. In the cutting step, the ascent-descent holder 30 can be used also as a scaffold.

FIG. 1C is a diagram for explaining a step for removing the cut part from the remaining part of the boiler. Therein, the aforementioned cut part P-1 is removed from the ascent-descent holder 30 (removal step). The removal step is carried out by lowering the holder 30, and moving the cut part P-1 in the direction of an arrow 300 by using an apparatus (not shown) for removing the cut parts. Examples of the apparatus include a fork lift, winch, crane or the like. Alternatively, it is possible to specially create a new machine exclusively for removing the cut parts. Thus, a first round of a disassembling operation is completed.

Thereafter, the height of the ascent-descent holder 30 is increased so that the holder 30 is brought to be close to or in contact with a cut end of the furnace 20 (holder lifting step). Then, the described cutting step and the removal step are carried out again in the same way as described above.

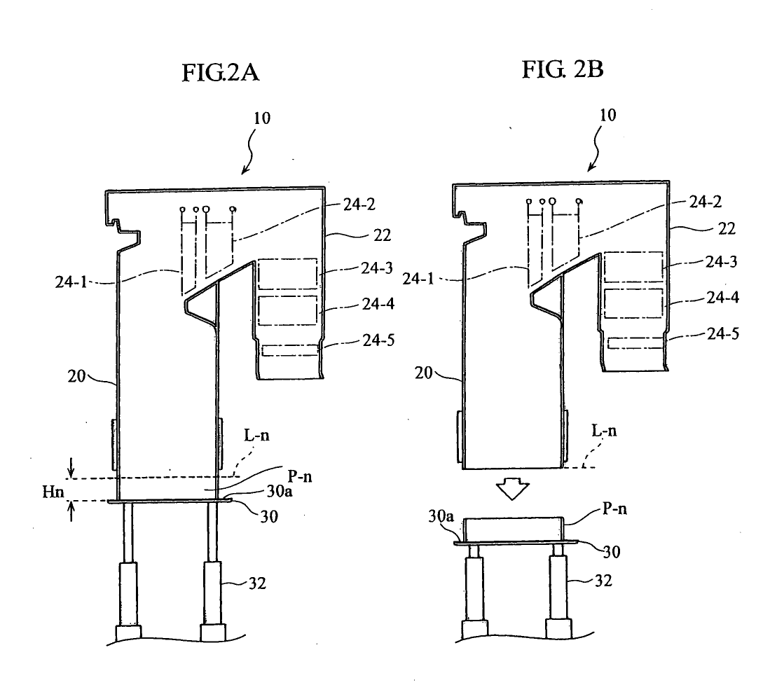

FIGS. 2A and 2B are diagrams for explaining a certain operational round included in a method for disassembling the boiler, wherein the furnace unit is further cut after the round shown in FIGS. 1A to 1C.

FIG. 2A is a diagram for explaining a holder lifting step and a cutting step with respect to the furnace unit, that are performed at a level higher than that in FIG. 1B. In other words, the holder lifting step shown in FIG. 2A is “n” rounds after the round shown in FIG. 1B. In accordance with the holder lifting step in FIG. 2A, the height of the ascent-descent holder 30 is increased to a position close to or in contact with an edge newly obtained (lower end). In the subsequent cutting step, the furnace unit 20 is horizontally cut along a dotted line L-n, that is away from the lower end by a height Hn.

FIG. 2B shows the state where the ascent-descent holder is lowered with a cut part P-n being maintained on the holder 30, after the steps shown in FIG. 2A. FIG. 2B also describes the following removal step for removing the cut part P-n from the holder 30.

After the holder installation step, the holder lifting step, the cutting step, and the removal step are repeated as described above, for disassembling the furnace unit 20 from the bottom side thereof.

When the furnace unit 20 is completely or partially disassembled, for instance to an upper part of the furnace unit 20, the ascent-decent holder 30 is displaced to a position below the heat recovery area 22. Then, the heat recovery area 22 is subjected to the disassembling operation including the holder lifting step, cutting step, and removal step, from the bottom part thereof. Thereafter, the suspension rods 14 for suspending the boiler 10 from the main girder 12c are cut. Thus, the method for disassembling the boiler of the invention is completed, and only the supporting structure (boiler building) remains.

According to the present invention, the cut parts (P-1, P-n, and etc.) from the furnace unit 20 or the heat recovery area 22 are maintained on the ascent-descent holder 30, without falling to the ground directly from the position/height where the cutting step is carried out. The cut parts are lowered by the ascent-descent holder 30, and then removed from the holder 30. Therefore, it is not necessary for the present invention to include laborious and complicated operations, which require a great deal of work. This is different from the jack-down method wherein the entire boiler body is lowered.

Accordingly, it is not necessary to concern about cut fire resistant material of the boiler 10 falling to the ground or the resulting powder being scattered to the surroundings.

Further, a large-scaled apparatus including jacks for suspending a boiler is not necessary for the present invention. Thus, it is possible to carry out the method of the present invention without causing problems to people and environment.

Moreover, the ascent-descent holder 30 can be relatively small, as long as the holder 30 can support the weight of the cut parts of the boiler 10. The holder 30 is used for disassembling the furnace unit 20 and the heat recovery area 22 separately. That also helps to minimize the size of the holder 30. Therefore, it is possible to suppress the cost for equipments.

In addition to the above, it is preferable that the furnace unit 20 and the heat recovery area 22 of the boiler 10 are cut along approximately horizontal cutting planes. This makes it easy and precise to provide the horizontally installed holder 30 closely to or in contact with the lower end (cut end) of the boiler 10 in the holder lifting step. After the cut end is evenly loaded on the holder 30, the cutting step is smoothly performed, and hence the cut parts (P-1, P-n) are stably maintained on the holder 30 without tilting or shifting therefrom.

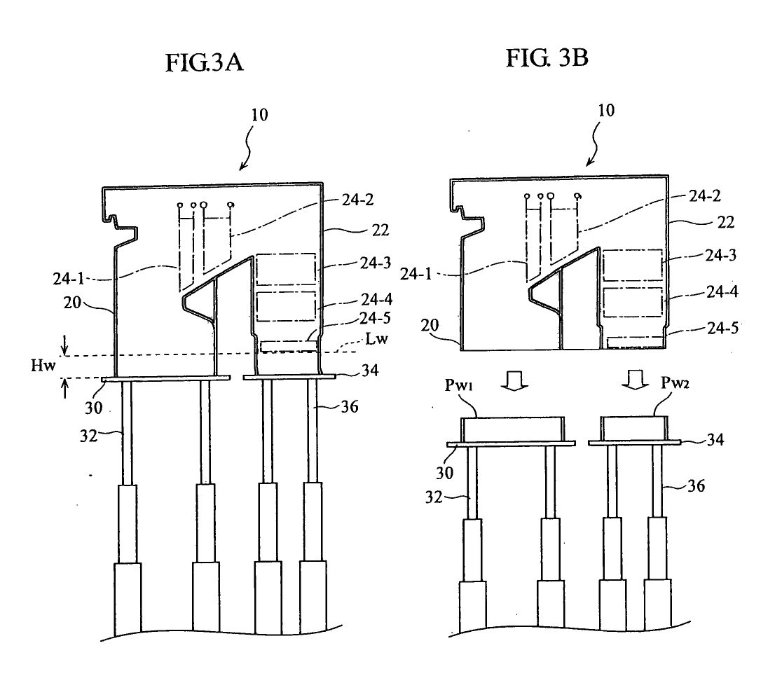

FIGS. 3A and 3B are diagrams for explaining a method for disassembling the boiler as another embodiment of the present invention. FIG. 3A is a diagram for explaining a cutting step, and FIG. 3B is a diagram for explaining a step for lowering the height of the ascent-decent holder which still carries the cut part of the boiler thereon. Here, explanations on members or parts already explained in FIGS. 1A to 1C and FIGS. 2B and 2C are omitted, and shown with the same reference numerals used therein.

A remarkable feature in this embodiment is that a disassembling operation is carried out with respect to the furnace unit 20 and the heat recovery area 22 in parallel, after the furnace unit 20 is disassembled to the level of a lower end of the heat recovery area 22. For the present embodiment, the ascent-descent holder 30 is used as a furnace unit holder for supporting the furnace unit 20, and another ascent-descent holder 34 is used as a heat recovery area holder for supporting the heat recovery area 22. The holder 34 is supported by jacks 36 at various levels in FIG. 3B.

In the present embodiment, the holders 30 and 34 are provided at a height that is close to or in contact with the cut end of the furnace unit 20 and the lower end of the heat recovery area 22, respectively. FIG. 3A shows that the furnace unit 20 and the heat recovery area 22 are cut along a dotted line Lw, that is away from the lower ends of the furnace unit 20 and the heat recovery area 22 by a height Hw. Then, cut parts Pw1 and Pw2 are removed from the boiler 10 in the subsequent removal step, as shown in FIG. 3B.

The use of the ascent-decent holders 30 and 34 makes it possible to cut the furnace unit 20 and the heat recovery area 22 in parallel, from lower ends of the units 20 and 22 (parallel disassembling operation). As a result, the boiler 10 can be disassembled quickly.

In the present embodiment, it is not always necessary to determine the heights (for instance, Hw) from the ends of the furnace unit 20 and the heat recovery area 22 to be the same with each other. Further, the removal steps with respect to the furnace unit 20 and the heat recovery area 22 do not have to be carried out simultaneously.

However, it is preferable that the cutting steps of the units 20 and 22 are carried out with the same height from the ends thereof, and that the removal step of the units 20 and 22 are carried out at the same time, in view of safety. More specifically, when a single holder is used in the cutting operation, at a location adjacent, for instance, to the heat recovery area 22, it is possible that an end of the holder catches a part belonging to the heat recovery area 22, such as a wiring or piping, and such parts are accidentally dropped and fall. It is possible to avoid this kind of accident by performing the cutting steps with respect to the furnace unit 20 and the heat recovery area 22 at the same time at the same level.

Alternatively, it is possible to use a single ascent-descent holder for the above-described parallel disassembling operation, which is large enough to support both the furnace unit 20 and the heat recovery area 22, instead of using holders 30 and 34. By using the single large holder, the same effect is obtained comparing to the case when the two holders 30 and 34 are used.

As another embodiment of the present invention, it is preferable to set the inner part of the boiler 10, which has not been disassembled yet, to a negative pressure. Accordingly, it is possible to avoid damages caused by a harmful cut substance. For providing a negative pressure within the boiler 10, open parts of the boiler is first closed by closure members, then, an apparatus including a piping for air suction is provided at an appropriate position of the boiler, and then the air in the boiler 10 is absorbed through the piping for air suction by using, for example, a fan. Since the position of the boiler 10 does not have to be changed and the boiler is maintained stationary during the disassembling operation, it is easy to provide the air-suction apparatus to the boiler, and to stably maintain the apparatus with respect to the boiler 10.

By the application of negative pressure in the present invention, the powder, which are formed when the boiler part such as the outer or inner casing of the furnace unit 20 is cut, is not released to the outside environment and is retained in the interior of the boiler 10. Accordingly, it is possible to eliminate possible environmental problems which can be caused by the harmful powder.

For closing the open parts of the boiler, it is possible to utilize the ascent-descent holder 30. Specifically, an open part of the boiler 10 can be closed by bringing the upper surface of the ascent-descent holder 30 in contact with the cut end of the boiler 10 (furnace unit 20) in the course of the holder lifting step.

Moreover, it is preferable to wrap the lower end of the boiler 10 by using a wrapping member such as a plastic sheet. By the provision of the wrapping member, it is possible to prevent a part of the boiler 10 such as a fire resistant material including asbestos from falling, or a small cut pieces or powder of the boiler 10 from scattering. Accordingly, the disassembling operation of the present embodiment is advantageous in view of environmental protection.

Furthermore, it is also possible to press the ascent-descent holder 30 to the lower end of the boiler 10, for instance to the cut end of the furnace 20, with pressure application. After the holder 30 is provided as shown in FIG. 1B or FIG. 2A, the holder 30, is pressed against the boiler 10 from the bottom side thereof. In this state, the boiler 10 is stably maintained even after cutting off the lower part of the boiler 10 without slippage or deviation. Then, the cut parts e.g., of a furnace 20 are firmly maintained between the furnace 20 and the holder 30, and do not fall to the ground. This results in safety in operation.

Furthermore, it is possible to remove the superheaters 24 provided in the heat recovery area 22 in the course of a cutting step, or removal step. For instance, it is possible to cut off the wall of the heat recovery area to a position close to a superheater installation, and then the height of the holder 30 is increased to the position close to or in contact with the superheater 24. Thereafter, it is also possible that the superheater 24 removed from the boiler is loaded on the holder 30 and that the holder 30 moves the superheater 24 off the boiler 10.

In the above-described the cutting step, it is possible to appropriately choose the height H1 or Hn of the cut parts, depending on the size of the boiler 10. The height H1 or Hn can be always the same throughout all the disassembling operations, or can be varied.

Furthermore, it is possible to choose the ascent-descent holder 30 having an appropriate size and configuration depending on the boiler 10. For instance, a relatively large holder 30 can be used for simultaneously for cutting the furnace unit 20 and the heat recovery area 22 thereon. This increases the disassembling speed.

The present invention being thus described, it will be clearly understood that the same may be varied in many ways. Such variations are not to be regarded as a departure from the spirit and scope of the present invention, and all such modification as would be easily understood to one skilled in the art are intended to be included within the scope of the appended claims.

What is claimed is:

1. A method for disassembling a boiler supported on a supporting structure by suspending therefrom; comprising:
a holder installation step for providing a vertically extendable ascent-descent holder below the boiler;
a holder lifting step for increasing a height of the ascent-descent holder to a position close to or in contact with a lower end of the boiler;
a cutting step for cutting off a lower part of the boiler, the lower part extending from the lower end of the boiler to a predetermined height; and
a removal step for removing the lower part from the holder, after the lower part has been cut off and the weight of the lower part has been transferred to the ascent-descent holder; the holder installation step, the holder lifting step, the cutting step, and the removal step being repeatedly carried out for successively disassembling the boiler from a bottom side thereof.

2. The method for disassembling a boiler as claimed in claim 1, wherein the boiler comprises a furnace unit, and a heat recovery area provided adjacent to the furnace unit, an upper part of the furnace unit communicating with an upper part of the heat recovery area, the ascent-descent holder being provided below the furnace unit in the holder installation step, and the furnace unit being subjected to the holder lifting step, cutting step and the removal step for disassembling the furnace unit from a bottom side thereof, the ascent-descent holder being displaced to a position below the heat recovery area in the holder installation step after the furnace unit is substantially disassembled, the heat recovery area being subjected to the holder lifting step, the cutting step and the removal step for disassembling the heat recovery area from a bottom side thereof.

3. The method for disassembling a boiler as claimed in claim 1, wherein the interior of the boiler in the course of the cutting step is set to a negative pressure.

4. The method for disassembling a boiler as claimed in claim 2, wherein the interior of the boiler in the course of the cutting step is set to a negative pressure.

5. The method for disassembling a boiler as claimed in claim 1, wherein the cutting step is carried out by cutting the boiler along horizontally extending cutting planes.

6. The method for disassembling a boiler as claimed in claim 2, wherein the cutting step is carried out by cutting the furnace unit and the heat recovery area along horizontally extending cutting planes.

7. The method for disassembling a boiler as claimed in claim 1, wherein the ascent-descent holder is pressed against the lower end of the boiler with a predetermined pressure in the holder lifting step.

8. The method for disassembling a boiler as claimed in claim 2, wherein the ascent-descent holder is pressed against each of a lower end of the furnace unit and a lower end of the heat recovery area with a predetermined pressure in the holder lifting step.

9. The method for disassembling a boiler as claimed in claim 1, wherein the boiler is used in the thermoelectric power plant.

10. A method for disassembling a boiler supported on a supporting structure by suspending therefrom; comprising:
a holder installation step for providing a vertically extendable ascent-descent holder below the boiler, the ascent-descent holder being extended by the provision of a jack provided below the boiler;
a holder lifting step for increasing a height of the ascent-descent holder to a position close to or in contact with a lower end of the boiler;
a cutting step for cutting off a lower part of the boiler, the lower part extending from the lower end of the boiler to a predetermined height; and
a removal step for removing the lower part from the holder, after the lower part has been cut off and the weight of the lower part has been transferred to the ascent-descent holder; the holder installation step, the holder lifting step, the cutting step, and the removal step being repeatedly carried out for successively disassembling the boiler from a bottom side thereof.

11. The method for disassembling a boiler as claimed in claim 10, wherein the boiler comprises a furnace unit, and a heat recovery area provided adjacent to the furnace unit, an upper part of the furnace unit communicating with an upper part of the heat recovery area, the ascent-descent holder being provided below the furnace unit in the holder installation step, and the furnace unit being subjected to the holder lifting step, cutting step and the removal step for disassembling the furnace unit from a bottom side thereof, the ascent-descent holder being displaced to a position below the heat recovery area in the holder installation step after the furnace unit is substantially disassembled, the heat recovery area being subjected to the holder lifting step, the cutting step and the removal step for disassembling the heat recovery area from a bottom side thereof.

12. The method for disassembling a boiler as claimed in claim 10, wherein the interior of the boiler in the course of the cutting step is set to a negative pressure.

13. The method for disassembling a boiler as claimed in claim 11, wherein the interior of the boiler in the course of the cutting step is set to a negative pressure.

14. The method for disassembling a boiler as claimed in claim 10, wherein the cutting step is carried out by cutting the boiler along horizontally extending cutting planes.

15. The method for disassembling a boiler as claimed in claim 11, wherein the cutting step is carried out by cutting the furnace unit and the heat recovery area along horizontally extending cutting planes.

16. The method for disassembling a boiler as claimed in claim 10, wherein the ascent-descent holder is pressed against the lower end of the boiler with a predetermined pressure in the holder lifting step.

17. The method for disassembling a boiler as claimed in claim 11, wherein the ascent-descent holder is pressed against each of a lower end of the furnace unit and a lower end of the heat recovery area with a predetermined pressure in the holder lifting step.

18. The method for disassembling a boiler as claimed in claim 10, wherein the boiler is used in the thermoelectric power plant.
